(19) United States
(12) Patent Application Publication
(10) Pub. No.: US 2003/0168525 A1
(43) Pub. Date: Sep. 11, 2003

(54) Fuel injection system

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/241,509

(22) Filed: Sep. 12, 2002

(30) Foreign Application Priority Data
Sep. 17, 2001 (DE) 1 01 45 822.3

(51) Int. Cl. F02M 59/00

(52) U.S. Cl. 239/533.2

(57) ABSTRACT

An injector of a pressure-controlled fuel injection system includes a locally disposed hydraulic pressure booster, a device for centrally generating a control pressure for actuating the pressure booster, and a metering valve for regulating the fuel inflow to the pressure chamber of the pressure booster.

### BACKGROUND OF THE INVENTION

1. Field of the Invention

The invention relates to an injector of a pressure-controlled fuel injection system with pressure boosting.

2. Description of the Prior Art

For the sake of better comprehension of the description and claims, some terms will now be defined: The fuel injection system of the invention is embodied as pressure-controlled. Within the scope of the invention, the term stroke-controlled fuel injection system is understood to mean that the opening and closing of the injection opening is done with the aid of a displaceable nozzle needle on the basis of the hydraulic cooperation of the fuel pressures in a nozzle chamber and in a control chamber. A pressure reduction within the control chamber causes a stroke of the nozzle needle. Alternatively, the deflection of the nozzle needle can be effected by means of a final control element (actuator). In a pressure-controlled fuel injection system of the invention, the nozzle needle is moved counter to the action of a closing force (spring) by the fuel pressure prevailing in the nozzle chamber of an injector, so that the injection opening is uncovered for an injection of the fuel from the nozzle chamber into the cylinder. The pressure at which fuel emerges from the nozzle chamber into a cylinder is called the injection pressure, while the term system pressure is understood to mean the pressure at which fuel is available or kept on hand within the fuel injection system. Fuel metering means delivering fuel to the nozzle chamber by means of a metering valve. In the unit fuel injector (UFI), the injection pump and the injector form a unit. One such unit per cylinder is built into the cylinder head and is driven either directly via a tappet or indirectly via tilt levers by the engine camshaft. The pump-line-nozzle system (PLN) operates by the same method. In that case, a high-pressure line leads to the nozzle chamber or nozzle holder.

An injector of the type with which this invention is concerned is known for instance from European Patent EP 0 562 046 B1. In this injector (HGUI system produced by Caterpillar), air bubbles can form in the pressure chamber because of the suction created as the piston moves into the closing position. Another disadvantage of this injector is the quantity metering. Nor can a preinjection be performed with the aid of this injector.

### OBJECT AND SUMMARY OF THE INVENTION

The high pressure is generated only locally. The control pressure of the control fluid is conversely generated centrally and can perform still other functions (such as valve control). The throttling of the high pressure by the metering valve at the intake has the advantage of simple quantity regulation. The injection event can be initiated and terminated by a 3/2-way valve.

Coupling two control valves for stroke-dependent pressure relief of the pressure chamber of the pressure booster makes it possible to embody an injector that is also capable of performing a preinjection.

Embodying the piston of the pressure booster in two parts means a subdivision into two pressure chambers, so that the first pressure chamber, controlled by a metering valve, is separated from a second pressure chamber that communicates with a nozzle chamber of the injector. As a result of this arrangement, the suction of fuel into the first pressure chamber does not cause the formation of air bubbles in the first pressure chamber.

Using a 2/2-way valve as a control valve for the pressure booster makes for a simple structural form of the injector with pressure boosting. A 3/2-way valve typically used is replaced by a 2/2-way valve and by the embodiment of a control conduit in the piston of the pressure booster. Integrating the control conduit with the piston reduces the space required for the injector.

### DESCRIPTION OF THE DRAWINGS

The invention will be better understood and further objects and advantages thereof will become more apparent from the ensuing detailed description of preferred embodiments taken in conjunction with the drawing, in which:

FIG. 1 shows a first injector with a locally disposed pressure booster;

FIG. 2 shows a second injector, with a coupling of two control valves in the pressure boosting;

FIG. 3 shows the course of the stroke of valve elements of the control valves and the course of the pressure in the control chamber for an injector of FIG. 2;

FIG. 4 shows a third injector with a two-part piston of the pressure booster;

FIG. 5 shows a fourth injector with a 2/2-way control valve; and

FIG. 6 shows a pressure booster in an alternative version to the pressure booster of FIG. 5.

### DESCRIPTION OF THE PREFERRED EMBODIMENTS

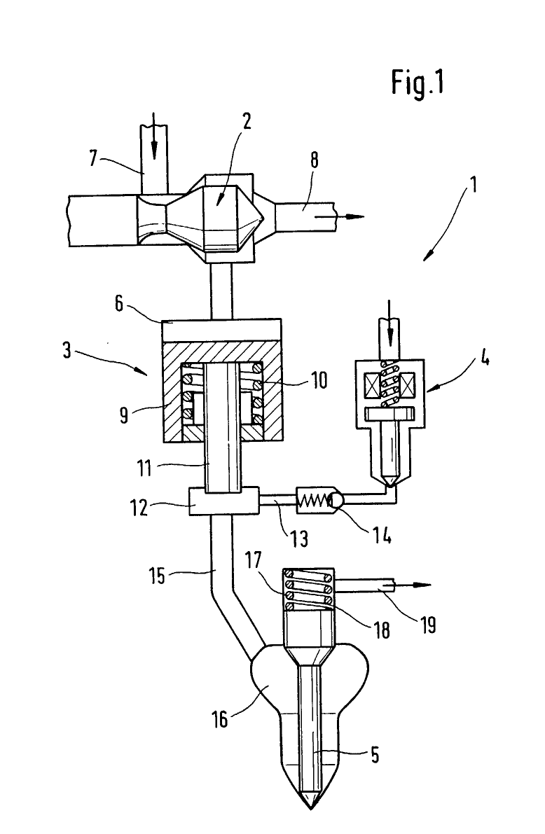

From FIG. 1 it can be seen that an injector 1 in a pressure-controlled fuel injection system includes a control valve 2, a local pressure booster 3 that operates on a hydraulic basis, a metering valve 4, and a nozzle needle 5. The 3/2-way control valve 2 serves to connect a control chamber 6 on the low-pressure side of the pressure booster 3 either to a supply line 7, in which a control fluid (such as oil, fuel, or a similar medium) that is at a centrally generated control pressure flows, or to a leak fuel line 8. At suitable pressure inside the control chamber 6, an outer piston 9 is moved in the direction of the nozzle needle 5 counter to the spring force of a closing spring 10. In the process, an inner piston 11 is subjected to pressure via the outer piston 9 and displaced, causing compression of fuel in the pressure chamber 12 on the high-pressure side, which chamber can be filled with fuel with the aid of the metering valve 4, a supply line 13, and a check valve 14. The filling is effected while the control chamber 6 is connected to the leak fuel line 8 (during pressure relief of the control chamber 6), in that fuel is aspirated into the pressure chamber 12 during the piston stroke (intake throttling, intake stroke of the piston 11). The aspirated fuel quantity is controlled by the metering valve 4. From the pressure chamber 12, the fuel that is at high pressure reaches a nozzle chamber 16 via the pressure line 15. If the pressure in the nozzle chamber 16 exceeds the spring force of a closing spring 17, the injection event is initiated. A pressure relief of a spring chamber 18 is effected by means of a further leak fuel line 19.

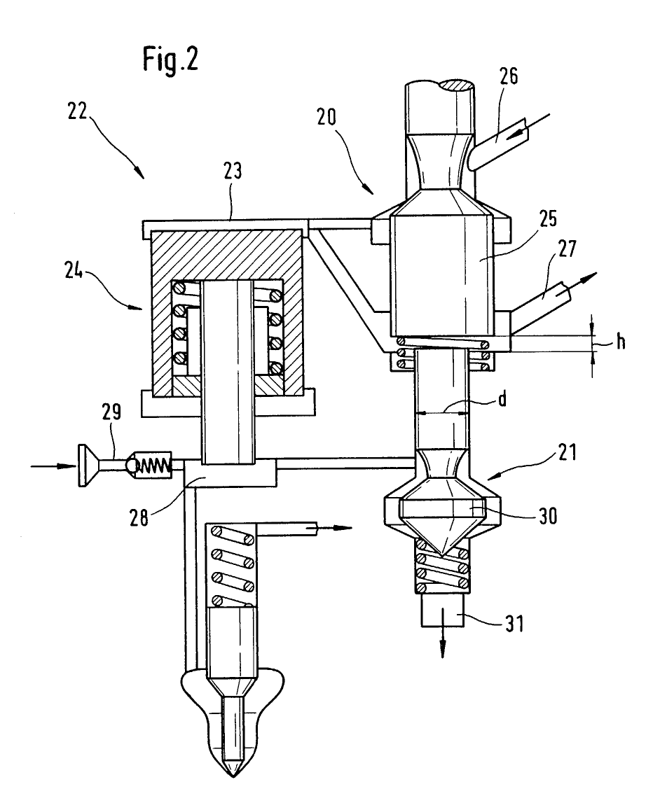

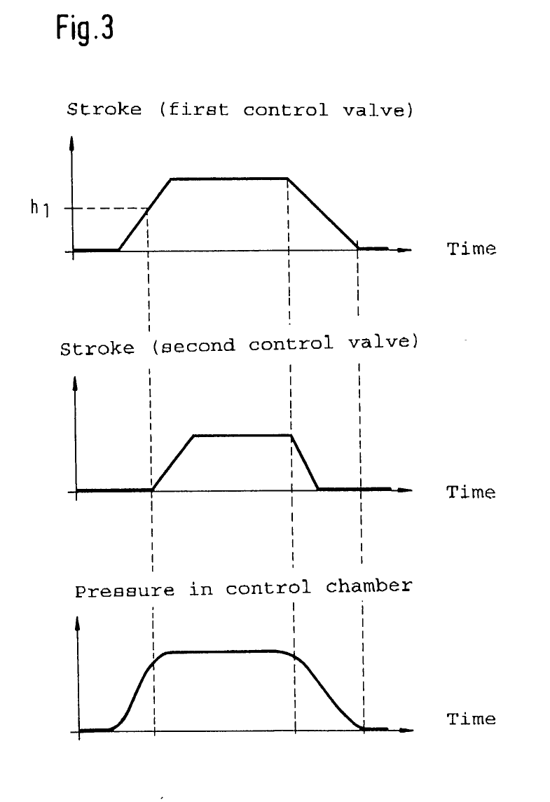

In FIG. 2, the functions of a first control valve 20 and a second control valve 21 in an injector 22 can be coupled. The filling of a control chamber 23 of a pressure booster 24 is regulated by a first displaceable valve element 25 of the first control valve 20. The control chamber 23 can in turn be connected either to a supply line 26, with a control fluid that is at a centrally generated control pressure, or to a leak fuel line 27. The connection to the supply line 26 results in a fuel compression in a pressure chamber 28 that can be filled with the aid of a metering valve 29 and a supply line. If the first valve element 25 is moved outward (downward in FIG. 2) via a stroke h, then a second valve element 30 of the second control valve 21 is deflected as well and initiates a pressure relief within the pressure chamber 28, by means of the resultant connection to a leak fuel line 31. The buildup of high pressure in the pressure chamber 28 is interrupted. This interruption can be utilized for a preinjection at lesser fuel pressure. Upon further motion, the connection to the leak fuel line 31 is closed again, so that a main injection becomes possible. The control valves 20, 21 are in a pressure-balanced state (see the uniform cross-sectional diameter d). The stroke-dependent pressure ratios in the control chamber and the shaping of the injection course can be learned from FIG. 3.

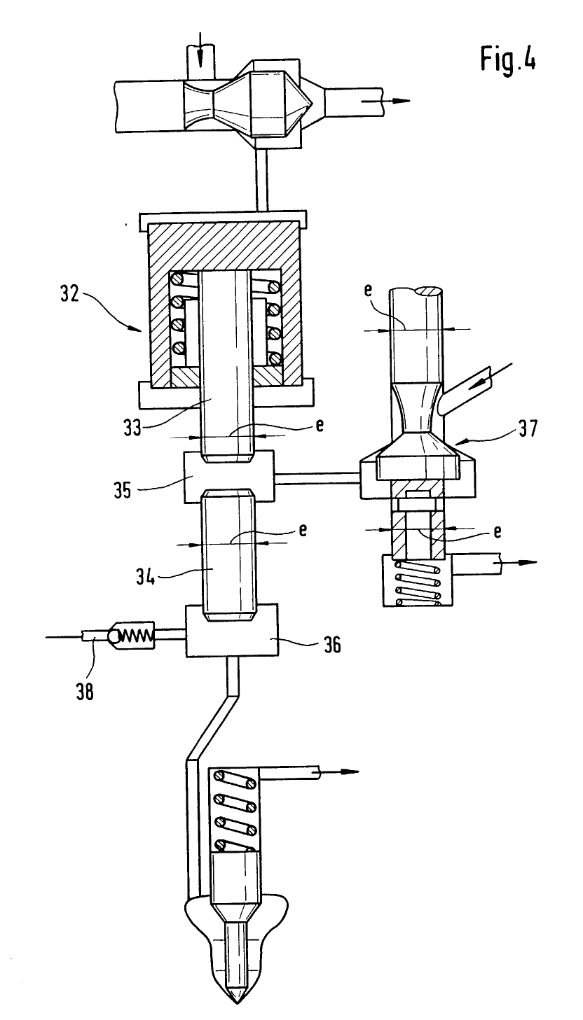

In FIG. 4, the inner piston used for pressure boosting in a pressure booster 32 is divided into two displaceable piston elements 33 and 34, which are separated from one another by a first pressure chamber 35. The cross sections e and the face areas acted upon by pressure are adapted to one another in such a way that a pressure boost of 1:1 occurs. From the volumetric adjustment in the pressure chamber 35, the volumetric adjustment in a second pressure chamber 36 is also obtained. The disposition of the first pressure chamber 35 and metering valve 37 as well as an inlet 38 and the second pressure chamber 36 (injection control chamber) has the result that the suction of fuel into the first pressure chamber 35 does not cause the formation of air bubbles in the first pressure chamber 35.

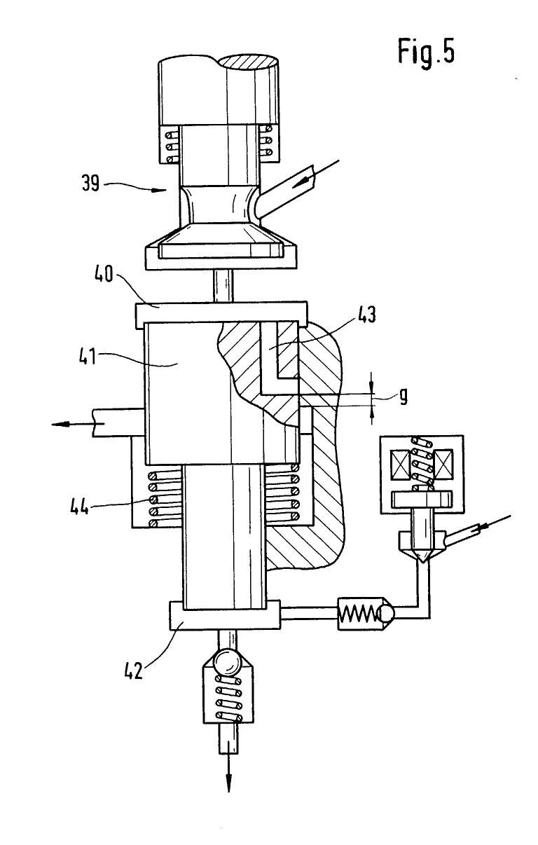

FIG. 5 shows that instead of a 3/2-way valve as the control valve, a 2/2-way valve 39 can also be used. A control pressure is generated centrally in a rail (pressure reservoir) and is continuously applied to the control valve 39. By opening the control valve 39, control fluid that is at control pressure is carried into the control chamber 40. A piston 41 is displaced as a result in the direction of the nozzle needle and compresses fuel in a pressure chamber 42. If the piston 41 exceeds a piston stroke g, the control chamber 40 is pressure-relieved via a control conduit 43 (forming a slide valve in the piston 41). If the control valve 39 is closed simultaneously, a lesser pressure develops in the control chamber 40. Because a closing spring 44 is provided, the piston 41 moves slowly back into its outset position. A slight overpressure is initially created in the control chamber 40, but this drops to ambient pressure. The pressure drop can be reinforced by the opening of the nozzle needle.

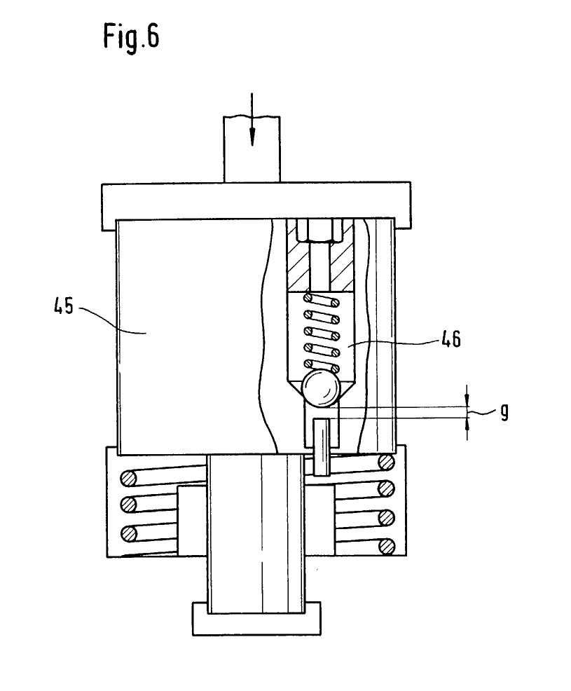

FIG. 6 shows an alternative version of the piston 41, with a slide valve, by means of a piston 45 with a ball valve 46.

The control valves and metering valves shown are actuated via magnets or piezoelectric actuators and because of their dimensioning are in the pressure-balanced state.

The foregoing relates to preferred exemplary embodiments of the invention, it being understood that other variants and embodiments thereof are possible within the spirit and scope of the invention, the latter being defined by the appended claims.

I claim:

1. An injector (1; 22) of a pressure-controlled fuel injection system, comprising
a locally disposed hydraulic pressure booster (3; 24; 32),
a device for central generation of a control pressure for actuating the pressure booster (3; 24; 32), and
a metering valve (4) for regulating the fuel inflow to the pressure chamber (12; 28; 35; 42) of the pressure booster (3; 24; 32).

2. The injector according to claim 1, further comprises a first control valve (20) with a displaceable first valve element (25) for filling a control chamber (23) on the low-pressure side of the pressure booster (24), and a second control valve (21) activatable by a displacement of the first valve element (25), the second control valve controlling a pressure relief of a pressure chamber (28) on the high-pressure side.

3. The injector according to claim 2, wherein the control valves (20, 21) are disposed in succession in the axial direction of the injector (22) and are embodied by double-seat valves.

4. The injector according to claim 1, further comprising a piston of the pressure booster (32) embodied in two parts, the piston parts (33; 34) being separated from one another by a pressure chamber (35) that can be filled with fuel via a metering valve (37).

5. The injector according to claim 2, further comprising a piston of the pressure booster (32) embodied in two parts, the piston parts (33; 34) being separated from one another by a pressure chamber (35) that can be filled with fuel via a metering valve (37).

6. The injector according to claim 3, further comprising a piston of the pressure booster (32) embodied in two parts, the piston parts (33; 34) being separated from one another by a pressure chamber (35) that can be filled with fuel via a metering valve (37).

7. The injector according to claim 1, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.

8. The injector according to claim 2, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.

9. The injector according to claim 3, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.

10. The injector according to claim 4, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.

11. The injector according to claim 5, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.

12. The injector according to claim 6, wherein the control valve (39) of the pressure booster is embodied as a 2/2-way valve; and wherein a piston (41) of the pressure booster has either a control conduit (43) that is displaceable as a function of stroke from a closing position into an opening position, or a ball valve (46) for connecting the control chamber (40) of the pressure booster to a leak fuel line.
